(19) United States
(12) Patent Application Publication
(10) Pub. No.: US 2010/0200211 A1
(43) Pub. Date: Aug. 12, 2010

(54) Green Cooling System For Outdoor Areas, Heat Transfer Units, and High Pressure Washing Utilizing a High Pressure Pump and a Multi-zone Controller

(76) Inventors: Ali Erturk, Wesley Chapel, FL (US); Gary Ramsey, Wesley Chapel, FL (US)

Correspondence Address: TUCKER LAW OFFICES, 61 RIDGEWAY DR, BROWNSBURG, IN, 46112, US

(21) Appl. No.: 12/368,361

(22) Filed: Feb. 10, 2009

(51) Int. Cl. G05D 23/00; F24H 9/00; F28D 15/00; F28F 13/12

(52) U.S. Cl. 165/287; 165/47; 165/104.31; 165/121

(57) ABSTRACT

The present invention relates to a high pressure multi-zone cooling system, including a high pressure pump and multi-zone controller, for cooling a plurality of normally air cooled air conditioning condensers, and/or refrigeration coolers, and/or heat exchangers. The system also may be used for independently cooling outdoor areas, and for pressure washing applications. The number of zones that can be cooled simultaneously is limited only by the maximum flow rates and pressures under which the high pressure pump can operate. Typical zones might be one or more air conditioner condensers or heat exchangers, one or more outdoor areas, or a combination of air conditioner condensers, heat exchangers and outdoor areas. Misting around an air conditioner condenser is normally off and is triggered only when the air conditioning unit's compressor is running. Misting of an outdoor area is activated by turning on the exterior or interior mounted wall switch controlling the zone for that outdoor area. The high pressure multi-zone cooling system also may be adapted for use in high pressure washing applications, which may be turned on by a switch on the multi-zone controller.

### FIELD OF THE INVENTION

The present invention relates generally to the fields of air conditioning and evaporative cooling, and particularly to a system including a high pressure pump and a multi-zone controller that together are capable of simultaneously and independently cooling as many zones as the pump's flow rates and pressures allow to provide evaporative cooling for outdoor areas, and/or A/C condensers and/or other heat transfer units, and/or provide high pressure washing capabilities.

### BACKGROUND OF THE INVENTION

No such system is known to us. One aspect of our system, A/C condenser cooling, has a number of devices that have been suggested to perfect the cooling of the A/C condenser. These prior art devices typically are aimed at wetting the condenser of the A/C system. One such device is described in U.S. Pat. No. 6,658,872 to James, and provides a pressure activated water control valve which supplies water from a water tap through a water line to one or more mist nozzles at a rate of about one gallon per hour at 100 psi water pressure. The water control valve receives a signal indicating high head pressure in the high pressure side of the refrigerant system from a tee adapter connected to the service valve connection present on most air conditioners. Thus the line running from the condenser to the water control valve is constantly pressurized at a level equal to the head pressure in the refrigerant high pressure side.

In operation the water valve is the main part of the James mist system. The head pressure controls the water valve. When the high pressure goes over a set point the water valve opens and lets water from the tap flow through the system to the mist nozzles. The set point must be optimized to maximize efficiency and minimize the risk of freeze up and the amount of water spilled on the ground.

### SUMMARY OF THE INVENTION

The present invention utilizes a single high pressure pump with a multi-zone controller capable of controlling high pressure water flow to as many zones as the system design and the pump's flow rates and pump pressures allow to simultaneously and independently cool single or multiple A/C condensers, and/or condensing units and/or other heat transfer units, and the like, and/or provide evaporative cooling to single or multiple outdoor or indoor areas, and/or provide a high pressure washing capability. This invention provides environmental benefits by reducing power consumption and generates financial savings for the user by cooling single or multiple A/C condensers, and/or condensing units and other heat transfer units, and/or by using an evaporative cooling system for cooling indoor or outdoor areas, and/or providing high pressure washing from a single high pressure pump with a multi-zone controller. The use of a single high pressure pump with a multi-zone controller both reduces the initial cost of the system and minimizes operating costs and environmental impact from the system, as well as extending the life expectancy of the existing condensers and compressors of the A/C systems, refrigeration units, coolers, and the like. The multi-zone controller will work with pumps in a myriad of applications and fields including, residential, commercial, agricultural, parks, marine, hydraulic, industrial, motor vehicle and aviation, and the like.

### BRIEF DESCRIPTION OF THE DRAWINGS

FIG. 1a Shows a schematic diagram of the cooling system for applying a fine mist spray of water to multiple air conditioner condenser units and to a covered outdoor patio.

FIG. 1b Shows a call out diagram of the multi-zone controller connected to a single pump.

### DETAILED DESCRIPTION OF THE INVENTION

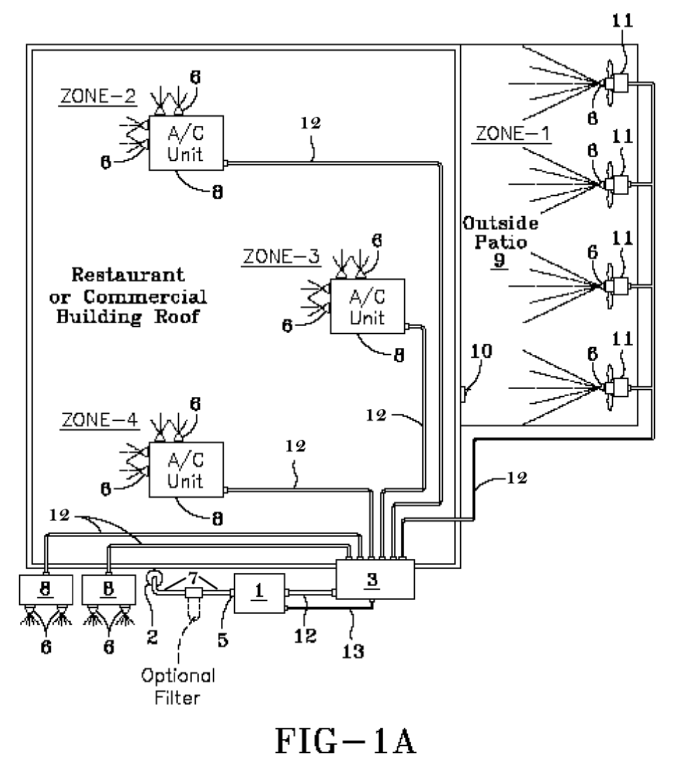

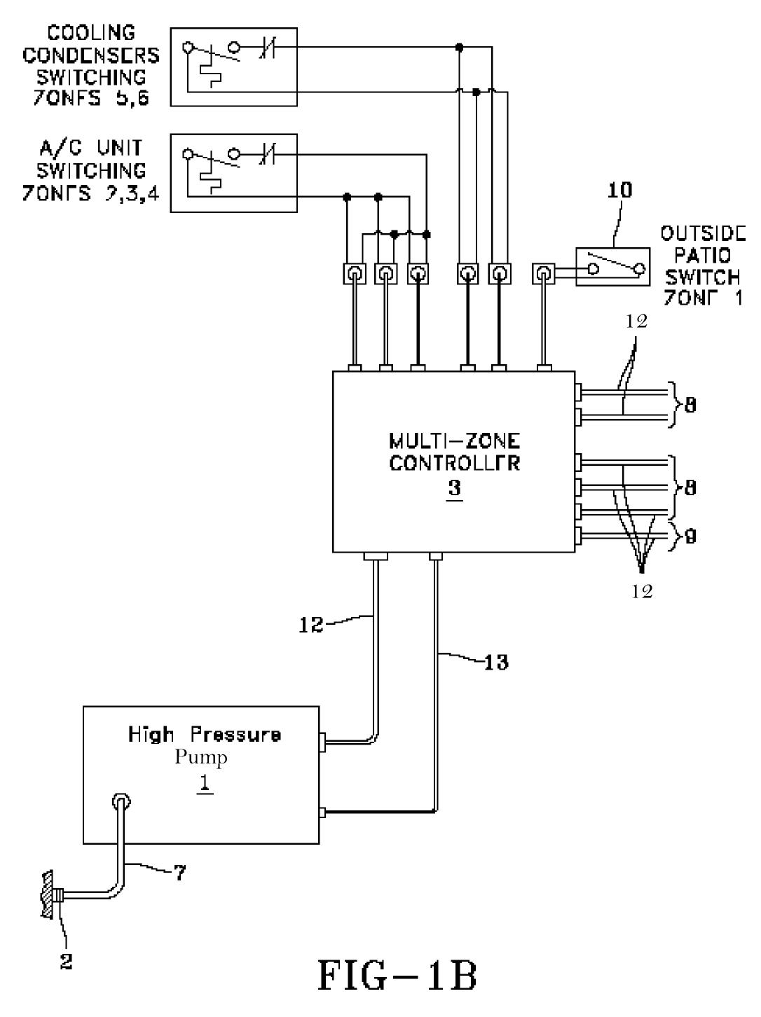

As shown in FIG. 1a water from a tap or other water source 2 flows through a water line 7 connected to an optional holding tank 4 then water line 7 connects to inlet 5 on a single high pressure pump 1. An optional intermediate water pre-filter, filtration cartridge, or other water purification device may be added in water line 7 between the water source 2 and the high pressure pump 1, or alternatively between the holding tank 4 and the high pressure pump 1, to remove sediment and control calcium buildup on the condenser coils, tubes, and fins, and reduce or prevent the build-up of minerals in the system that may clog the misting nozzles 6 and prevent them from misting effectively. Other water treatment devices, such as a water softener or reverse osmosis water purifier, and the like, may be tied into the water feed to the water source 2. The high pressure pump 1 is connected to the multi-zone controller 3 through high pressure discharge line 12. The high pressure pump 1 with the multi-zone controller 3 operates at higher pressures, for example pressures from 100 psi up to 4000 psi, than the prior art systems which generally operate at 30-100 psi. Thus the high pressure pump 1 and multi-zone controller 3 of the present invention produce a finer, faster evaporating mist that creates less moisture in the area around the misting nozzles 6. In addition, by cooling the air around the A/C condenser the A/C compressor draws fewer amps and cools the building or other area more quickly, thus reducing energy consumption by as much as thirty percent, lowering operating costs, and extending A/C component life. In addition, the single high pressure pump 1 with multi-zone controller 3 of the present invention also is capable of distributing water to as many misting nozzles 6 as the system's design, pump flow rates, and pump pressures allow. The system also can be synchronized to work independently or simultaneously with each A/C system, thus making the start up equipment costs less than the cost of prior art systems, which typically require two pumps that are placed in a single cabinet and are capable of misting only two zones per pump, whereas the system of the present invention is capable of misting as many zones as the high pressure pump's flow rates and pressures allow. The high pressure pump 1 and multi-zone controller 3 of the present invention are custom built to address customer and/or application needs, and may be configured with any voltage or hertz cycle combinations to meet those needs. The high pressure pump 1 and multi-zone controller 3 may be enclosed in a single cabinet, or separate cabinets, or operated without enclosure based on application needs and customer desires.

In one embodiment of the system of the present invention, as shown in FIG. 1a, water from the water source 2 flows through water line 7 to an optional holding tank 4. An additional water line 7 connects holding tank 4 to inlet 5 of the high pressure pump 1. High pressure pump 1 pumps the high pressure water through a high pressure discharge line 12 to the multi-zone controller 3. The multi-zone controller 3 then distributes the high pressure water through additional high pressures discharge lines 12 to one or more misting nozzles 6 mounted on the A/C condenser units, ground level refrigeration units 8, and other heat exchangers (not shown in the drawings) that are activated by the multi-zone controller 3 to mist the selected zones. The three roof top A/C condenser units and two ground level cooling condensers 8, represent five of the six zones in this embodiment. The misting nozzles 6 spray a fine mist of water in front of the A/C and cooling condenser units 8. The condenser units' 8 fans then draw the cooled air through the condenser coils to cool the condenser coils and fins. The fine mist of water evaporates rapidly cooling the air around the condenser units 8. The cooled air draws the heat from the condenser units' 8 coils more efficiently, thus allowing the condenser units 8 to operate under less stress and amperage draw, and at lower pressures with operating costs that may be up to thirty percent lower than without the system because the cooled air speeds the rate of heat transfer to the environment. Where it is desirable to simultaneously cool more than one condenser unit 8, other zones of the multi-zone controller 1 activate the misting nozzles 6 for the additional condenser units 8 in a manner similar to that described above. Each zone is operated independently by the control that engages the unit 8 for that zone. Thus the misting nozzles 6 around a particular A/C unit 8 are activated only when that A/C unit's compressor is running. In cases where the A/C unit 8 is also a heat pump the high pressure multi-zone pump 1 is synchronized to know the difference and does not operate on a heat setting. In all cases the multi-zone controller 3 is synchronized to operate with various sensors that engage the various zones, solenoids, and valves of the multi-zone controller 3.

In a second embodiment of the system of the present invention, also as shown in FIG. 1a, the misting nozzles 6 are mounted around outdoor areas 9, such as over a deck, patio, or lanai, and the like. The fine mist of water from misting nozzles 6 draws heat from the surrounding air as it evaporates thus cooling the air within the outdoor area 9. To increase the efficiency of the system in cooling outdoor areas, fans 11 or other air circulation method, and the like, optionally may be mounted behind the misting nozzles 6 to assist in moving the cooled air throughout the outdoor area 9. In this case the mist is activated by turning on the misting nozzles 6 and fans 11 or other air circulation method, and the like, for each outdoor area 9 independently by activating the interior or exterior electric wall switches 10 for the desired outdoor spaces 9. Alternatively, the mist nozzles 6 and fans 11 for the various zones may be turned on at the multi-zone controller or they may be configured to operate by remote control and the like.

In a third embodiment of the system of the present invention, also as shown in FIG. 1a and FIG. 1b the high pressure pump 1 pumps the high pressure water through high pressure discharge line 12 to the multi-zone controller 3. Then the multi-zone controller 3 distributes the water through one or more high pressure discharge lines 12 and/or one or more high pressure discharge lines for pressure washing 15 to one or more high pressure washing connection fittings 16 suitable for connecting high pressure washing accessories, such as a high pressure washing hose and a high pressure washing wand. When there is more water being pumped than a particular zone or combination of zones need, based on pump flow rates, pressures and application design, the excess water would flow through optional bypass line 14 into the optional holding tank 4. When optional holding tank 4 is utilized there will be additional components required within the tank. One such component would be a flow sensor, or fluid level sensor, or float mechanism or pressure sensor, or the like, preferably float mechanism, which determines the fluid level in holding tank 4 and activates a solenoid or valve, or the like, preferably a valve, when the water level in holding tank 4 is low to allow water to flow into the holding tank 4 from the water source 2 through water line 7. Conversely when holding tank 4 is full of water the flow sensor, or fluid level sensor, or float mechanism or pressure sensor, or the like, preferably float mechanism would indicate that holding tank 4 is full and the solenoid or valve, or the like, would turn off the flow of water.

In a similar manner the system of the present invention may be used to cool indoor areas, such as warehouses, shops, factories, office complexes, apartment complexes, residential units, garages, barns, convention centers, gymnasiums, and the like, or combinations thereof.

In a fourth embodiment of the system of the present invention, the multi-zone controller also may be used to control multiple pumps, and/or a high pressure washing system, and/or for other applications requiring the delivery of water under high pressure.

Since each zone of the multi-zone controller 3 is independent of the other zones and is triggered either by the thermostatic controls in case of misting nozzles 6 mounted on single or multiple condensing and/or heat exchanger units 8, or by wall switches 10 in the case of misting nozzles 6 and fans 11 or other air circulation method, and the like, mounted around single or multiple outdoor spaces 9, or by remote control, the misting nozzles 6 are separately triggered to cool one or more condensing and/or heat exchanger units 8 and/or one or more interior or exterior areas 9 independently as desired.

The cooling system of the present invention also may be utilized in a myriad of other fields and applications, including residential, industrial, commercial, agricultural, park, marine, aviation, motor vehicle, rail (train), motorized vessel and vehicle applications, hydraulic, heat transfer, and the like.

While the present invention has been described in terms of a general embodiment and four specific embodiments, it is recognized that a person skilled in the air conditioning, evaporative cooling, pressurized pumps and pumping systems, mechanical, and electrical arts will readily perceive many modifications and variations in the embodiments described above. Such modifications and variations are included within the scope of the present invention.

We claim:

1. An environmentally beneficial cooling system for cooling a plurality of units for A/C, refrigeration, and heat exchanger condensing units, and the like; and for simultaneously and independently cooling a plurality of indoor areas, such as offices, factories, warehouses, manufacturing facilities, agricultural applications such as barns and greenhouses, apartment complexes, residential units, convention centers, gymnasiums and the like; or simultaneously and independently cooling a plurality of outdoor areas, such as patios, decks, lanais, and the like; or combinations thereof; comprising:
a water source;
a high pressure pump;
a multi-zone controller,
a plurality of misting nozzles mounted on or around one or more A/C units, or heat exchanger units, or refrigeration condensing units, and the like; or around one or more outdoor or indoor areas;
switches to activate the misting nozzles mounted around the outdoor or indoor areas;
water lines for delivering the water from the water source to one or more high pressure pumps; and
high pressure discharge lines for delivering high pressure water from the high pressure pumps to the multi-zone controller, and from the multi-zone controller to the misting nozzles.

2. The cooling system of claim 1 where in an optional holding tank is disposed between the water source and the high pressure pump.

3. The cooling system of claims 1 and 2 wherein an optional water pre-filter, or filtration cartridge, or other water purification device is disposed in the water line between the water source and the high pressure pump, or between the optional water tank and the high pressure pump.

4. The cooling system of claims 1 through 3 wherein optional fans or other air circulation method, and the like, are mounted with the misting nozzles around outdoor areas to assist in moving the cooled air though out the outdoor areas.

5. The cooling system of claims 1 through 4 wherein the switches are electrical wall switches, or are activated at the multi-zone controller, or by remote control.

6. The cooling system of claims 1 through 5 wherein the multi-zone controller is custom built to address customer or application needs, and may be configured with any voltage or hertz cycle combinations to meet those needs.

7. The cooling system of claims 1 through 5 wherein the high pressure pump is custom built to address customer or application needs, and may be configured with any voltage or hertz cycle combinations to meet those needs.

8. The cooling system of claims 1 through 7 wherein the high pressure pump and multi-zone controller are combined into an assembly.

9. The cooling system of claims 1 through 8 wherein the high pressure pump is capable of operating at pressures above 100 psi

10. The cooling system of claim 9 wherein the high pressure pump is capable of operating at pressures from 100 psi to 4000 psi.

11. The cooling system of claims 1 through 9 wherein each zone of the multi-zone controller operates independently of the other zones, and the multi-zone controller is capably of cooling multiple separate zones independently or simultaneously, and there is no limit to the possible configurations of the system.

12. The cooling system of claims 1 through 11 wherein each zone of the multi-zone controller can be synchronized to operate with devices that indicate a demand, such as a thermostat or thermostatic control, pressure sensor, temperature sensor, flow sensor, airflow sensor, humidity sensor, rain sensor, or other device utilized to trigger or engage the various zones, solenoids or valves of the multi-zone controller.

13. The cooling system of claims 1 through 12 wherein the misting nozzles are mounted on or placed around condensing units or heat exchange units for buildings.

14. The cooling system of claims 1 through 13 wherein the misting nozzles are mounted or placed around outdoor areas with or without fans or other air circulation method, and the like.

15. The cooling system of claims 1 through 13 wherein the misting nozzles are mounted on or around indoor areas with or without fans or other air circulation methods, and the like.

16. The cooling system of claims 1 through 15 wherein the misting nozzles are mounted on or around an unlimited combination of condensing units, or outdoor or indoor areas.

17. The cooling system of claims 1 through 16 wherein one or more of the zones of the multi-zone controller are connected through high pressure discharge lines to one or more high pressure water outlets attached to the exterior of a building, said outlets being designed for attaching various high pressure washing accessories.

18. The cooling system of claims 1 through 16 wherein an optional holding tank is placed between the water source and the high pressure pump.

19. The cooling system of claims 1 through 17 wherein an optional bypass hose from the high pressure pump to the holding tank is used to move excess water from the high pressure pump to the holding tank.

20. The cooling system of claims 1 through 18 wherein the optional holding tank has a flow sensor, or fluid level sensor, or float mechanism or pressure sensor, or the like, preferably a float mechanism, to determine the fluid level in the tank and activate a solenoid or valve, or the like, preferably a valve, when the tank is low to fill the tank with fluid, and conversely when the tank is full to turn off the flow of fluid.

21. The use of the cooling system of claims 1 through 20 for cooling residential, commercial, industrial, and agricultural applications, for example warehouses, shops, factories, barns, office complexes, apartment complexes, convention centers, gymnasiums, and residential units; including cooling condensers and indoor and outdoor areas and the like.

22. The use of the cooling system of claims 1 through 21 for high pressure washing applications.

23. The use of the cooling system of claims 1 through 21 wherein the system can be utilized in a myriad of fields and applications, including residential, industrial, commercial, agricultural, park, marine, aviation, motor vehicle, rail (train), motorized vessel and vehicle applications, hydraulic, heat transfer, and the like.
